(19) United States
(12) Patent Application Publication
(10) Pub. No.: US 2012/0240066 A1
(43) Pub. Date: Sep. 20, 2012

(54) METHOD AND APPARATUS FOR EFFICIENT CUSTOMIZATION OF A USER INTERFACE LIBRARY

(75) Inventors: Leon Marc Bovett, Willingham (GB); Shashikant Bhalchandra Kulkarni, Bangalore (IN)

(73) Assignee: NOKIA CORPORATION, Espoo (FI)

(21) Appl. No.: 13/051,926

(22) Filed: Mar. 18, 2011

(51) Int. Cl. G06F 3/048

(52) U.S. Cl. 715/762

(57) ABSTRACT

A method comprises applying a set of common device-specific definitions for a user interface of a device; using application-specific definitions to over-ride select common definitions, the application-specific definitions being applicable to one or more applications on the device; and applying widget-type-specific definitions, each of the widget-type-specific definitions being applicable to one or more applications corresponding to a widget type. In one embodiment, the definitions are stored in a shared memory.

### TECHNICAL FIELD

The present application relates generally to user interfaces and, more particularly, to customization of the user interface library of a device.

### BACKGROUND

User interface design on mobile devices provides challenges compared to a desktop user interface environment. For mobile devices, the user interface must be customized for the particular device, as well as for particular applications on the device.

### SUMMARY

Various aspects of examples of the invention are set out in the claims.

According to a first aspect of the present invention, a method comprises applying a set of common device-specific definitions for a user interface of a device; using application-specific definitions to over-ride select common definitions, the application-specific definitions being applicable to one or more applications on the device; and applying widget-type-specific definitions, each of the widget-type-specific definitions being applicable to one or more applications corresponding to a widget type.

According to a second aspect of the present invention, an apparatus comprises at least one processor; and at least one memory including computer program code, the at least one memory and the computer program code configured to, with the at least one processor, cause the apparatus to perform at least the following: apply a set of common device-specific definitions for a user interface of a device; use application-specific definitions to over-ride select common definitions, the application-specific definitions being applicable to one or more applications on the device; and apply widget-type-specific definitions, each of the widget-type-specific definitions being applicable to one or more applications corresponding to a widget type.

According to a third aspect of the present invention, a computer-readable medium including computer executable instructions which, when executed by a processor, cause an apparatus to perform at least the following: apply a set of common device-specific definitions for a user interface of a device; use application-specific definitions to over-ride select common definitions, the application-specific definitions being applicable to one or more applications on the device; and apply widget-type-specific definitions, each of the widget-type-specific definitions being applicable to one or more applications corresponding to a widget type.

### BRIEF DESCRIPTION OF THE DRAWINGS

For a more complete understanding of example embodiments of the present invention, reference is now made to the following descriptions taken in connection with the accompanying drawings in which:

FIG. 1 is a schematic illustration of a customization system for user interface library components in accordance with an embodiment;

FIG. 2 is a flow chart illustrating a process for customization in accordance with an embodiment;

FIG. 3 is a flow chart illustrating a process for generating widget-type-specific definitions in accordance with an embodiment;

FIG. 4 is a schematic illustration of layered style stacks in accordance with an embodiment;

FIG. 5 is an overview diagram of a system within which various embodiments may be implemented; and

FIG. 6 is a schematic representation of the circuitry which may be included in an exemplary electronic device which may be utilized in accordance with the various embodiments.

### DETAILED DESCRIPTION OF THE DRAWINGS

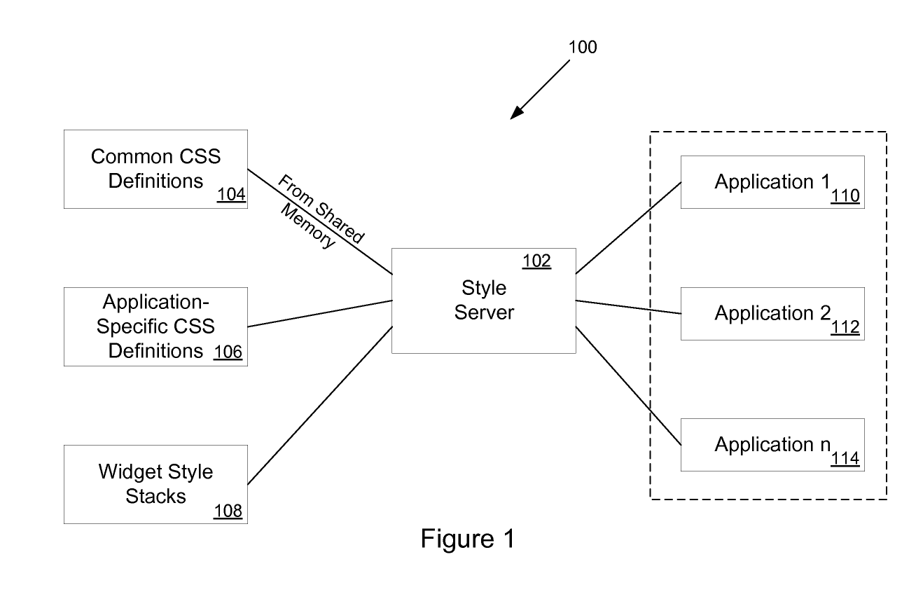

Example embodiments of the present invention and their potential advantages are understood by referring to FIGS. 1-6 of the drawings.

In order to provide a fully flexible customization system for library user interface components (referred to as “widgets” herein), a styling system should be provided so that mobile device manufacturers can customize the user interface in order to differentiate their own products. In this regard, all applications, constructed by combining widgets, display the same style of customized widget content when running on a particular device. On the other hand, the same set of applications, running on a different device, display different customized content tailored to the needs of that other device. For example, the customization may be directed to a different form factor of the device or a different target market.

Such customization has several obstacles, particularly when applied to mobile devices. For example, consider a library of platform widgets that need to be presented using device-specific style data on a given device, while also being adjustable and customized differently for particular use cases found only in specific applications. In order to provide a flexible system for both global and local customization of an extensible library of widgets, the customization data must be processed both globally (across all running applications) and locally (within the application process) across applications on the device, while overcoming a number of potential performance bottlenecks. These performance bottlenecks may include the need to reduce the number of times that the style data is read from the file system, parsed, and also processed for each widget instance in all of the currently running applications. Further, the global widget style data must be combined with the local application-specific style data, while reducing the amount of inter-process communication. Finally, when applying the style data to a specific widget, it is important to avoid parsing style data associated with other widgets.

Embodiments of the present invention provide systems and methods for efficient customization of user interfaces. In this regard, certain embodiments of the present invention make use of cascading style sheets (CSS), which are known to those skilled in the art for use in rendering web pages and specifying detailed layout of the content on the web pages. In accordance with embodiments of the present invention, CSS files may be used to implement individual applications, where each application may be treated as a web page.

Referring now to FIG. 1, a schematic illustration of a customization system 100 for user interface library components in accordance with an embodiment is provided. In the illustrated embodiment, a style server 102 provides centralized coordination and management of the customization system 100. In addition to coordinating the management of the shared memory, the style server 102 may also provide centralized CSS data parsing facilities.

The style server 102 provides access to a shared memory to all applications. The shared memory contains common CSS definitions 104, which include a default set of device-specific global definitions to be applied to all applications (e.g., applications 110, 112, 114) of a particular device or type of device. In addition to the common CSS definitions, a set of application-specific CSS definitions 106 may be provided to the applications. The style server 102 may determine the identity of the applications 110, 112, 114 on the device and may retrieve the appropriate application-specific definitions 106. Finally, a set of widget style stacks 108 is made available to the style server 102.

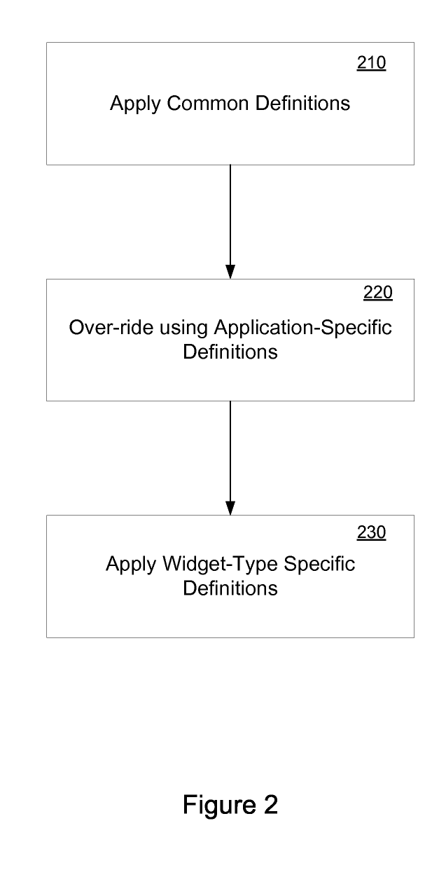

Referring now to FIG. 2, a flow chart illustrating a process for customization in accordance with an embodiment is provided. As described above with reference to FIG. 1, in order to provide a centralized styling system for a large number of applications running on a device, the CSS styling system is provided as a central service. In this regard, common CSS definitions are parsed and loaded only once into a shared memory system. Thus, at block 210 of FIG. 2, the device-specific common CSS definitions are applied to all applications of the device. The common CSS definitions can then be overridden (block 220) by application-specific CSS definitions. As illustrated in FIG. 1, the style server 102 may obtain the application-specific CSS definitions and may apply them to the select applications, thereby altering a reduced set of values compared to all of the applications on the device to which the device-specific common CSS definitions are applied. Finally, CSS definitions corresponding to specific widget types are loaded into separate “widget style stacks” in order to reduce the amount of processing needed for each widget. The widget-type-specific definitions (e.g., widget style stacks) may then be applied to applications corresponding to the widget types (block 230).

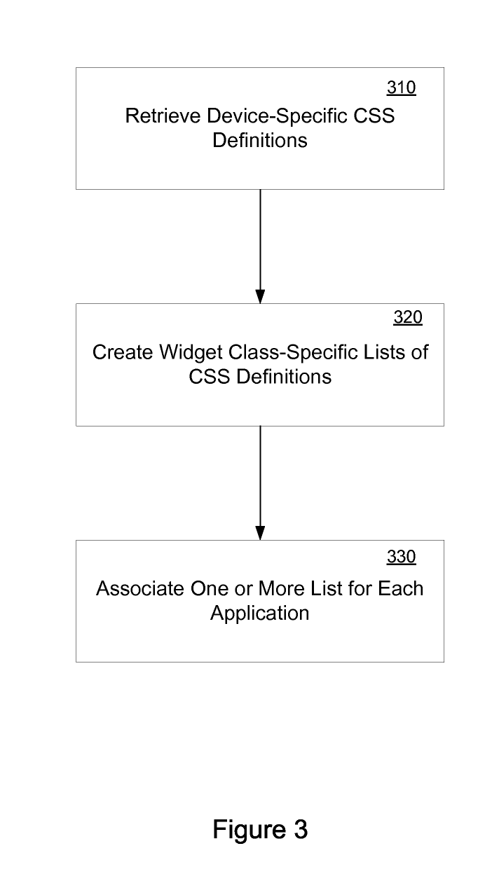

Referring now to FIG. 3, a flow chart illustrating a process for generating widget-type-specific definitions and/or widget style stacks in accordance with an embodiment is provided. As noted above, the device-specific customization files (e.g., common CSS definitions) are loaded from a file system and stored in shared memory (block 310). When each CSS file is parsed by, for example, the style server 102, each CSS selector is put into a list corresponding to a widget class which matches the selector. Doing so with all common CSS definitions results in widget-class-specific lists of CSS definitions (block 320).

Each widget-class-specific list may be associated with one or more applications. Further, each application may correspond to zero or more lists. The style implementation for each application of the device stores a list of lists of CSS selectors for each widget class that is instantiated within the application. This may be a subset of the total available widget library according to the needs of the application. One of the lists may refer to the global shared CSS data for that widget; another list may refer to the application-specific CSS that is loaded into that application, but may also correspond to an overlapping set of widgets. There may be a number of such layers according to the needs of the platform. The layout system for each widget looks at the correct list of CSS selectors, corresponding only to that widget, but also combining the global data with the local application-specific overrides.

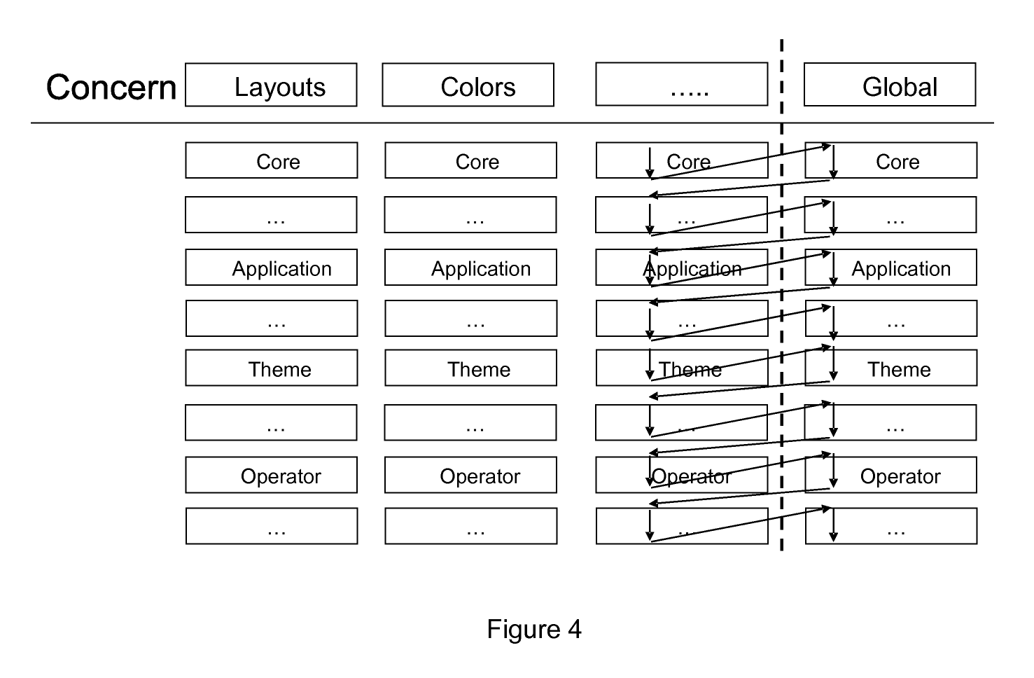

Referring now to FIG. 4, a schematic illustration of layered style stacks in accordance with an embodiment is provided. The user interface of the device may be divided into a variety of concerns which may be independent of each other, such as layout, color, etc. Each concern has a corresponding CSS layer stack, and separating the concerns improves efficiency of processing or searching through the unrelated values. Each stack has different layers of customization, such as core, application, theme, etc. In this regard, the core layer of customization may correspond to a default style which may be applicable to all aspects of the user interface (e.g., the official platform style). Other layers of customization (e.g., application, theme, etc.) may correspond to the needs of various other stakeholders, each of which may be progressively more specific.

In various embodiments, the layered stacks may be created to specifically correspond to desired layers addressing the needs of the different stakeholders. For example, some applications may require minor variants of platform components to achieve a certain specific functionality while reusing a common implementation. Further, external customers, such as network operators may have their own branding requirements that change the default behavior or appearance in order to create modified or differentiated devices. These layers are cumulative, so application-specific enhancements could still be modified by theme or operator-specific overrides.

Embodiments of the present invention provide numerous benefits. For example, by loading the global CSS definitions in one process, the number of times that the style data is read and parsed is reduced when compared against the need for loading global CSS definitions for each application. In this regards, in various embodiments, a demand-based binary caching system may be used to improve the speed/memory performance of loading and parsing the style data into memory.

Further, storing the style data in a shared memory allows it to be loaded by the central process, while still being accessed (in a read-only manner) by each separate application.

Further, by splitting the CSS selectors according to the target widget, when processing the layout data for a specific widget instance, only the relevant selectors need to be processed, reducing the amount of selectors.

By storing the global style data in shared memory and the application-specific style data in local memory, while combining the two kinds of data into the same containers, the global and local style data can be efficiently combined in order to provide the final resolved style CSS selectors for a given widget that is running in a given application.

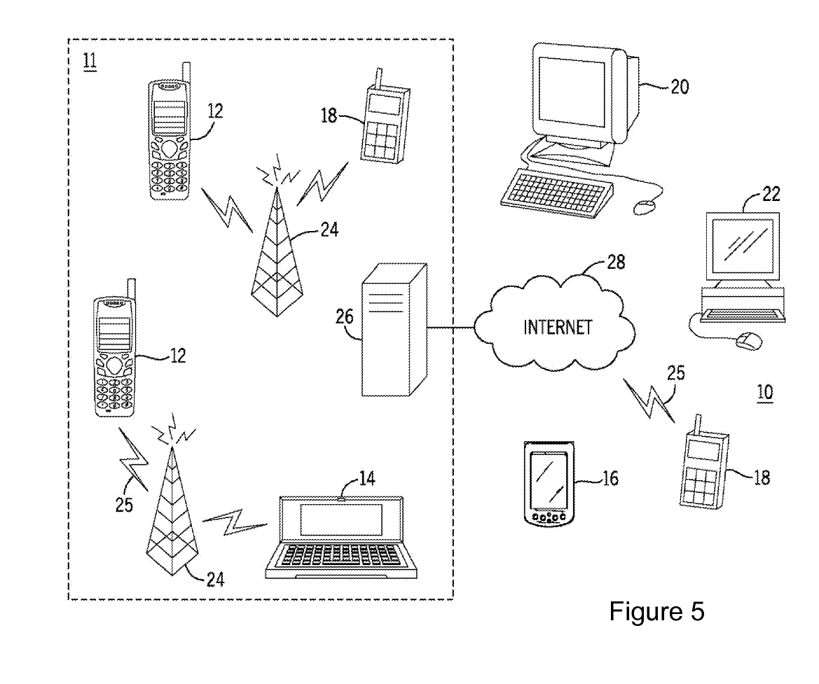

FIG. 5 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

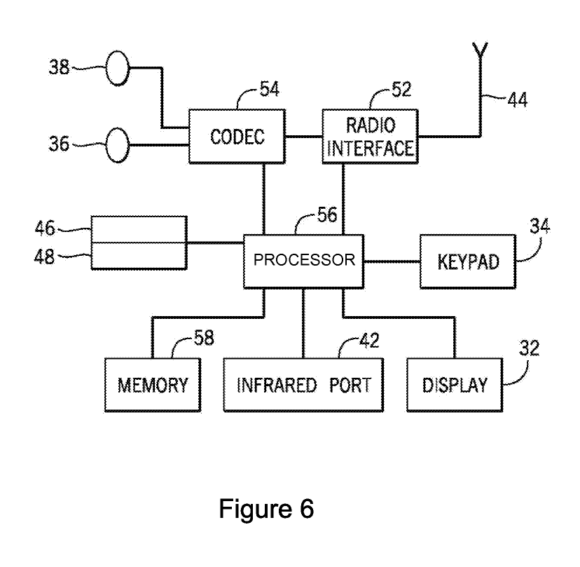

FIG. 6 shows one representative electronic device which may be used in accordance to the various embodiments of the present invention. In embodiments of the present invention, the device of FIG. 6 may be representative of a client device, a streaming server or a network device. It should be understood, however, that the scope of the present invention is not intended to be limited to one particular type of device. The electronic device of FIG. 6 may include a housing, a display in the form of a liquid crystal display, a keypad 34, a microphone 36, an ear-piece 38, a battery, an infrared port 42, an antenna 44, a smart card 46 in the form of a UICC according to one embodiment, a card reader 48, radio interface circuitry 52, codec circuitry 54, one or more processors, such as processor 56, and one or more memories, such as memory 58. The above described components enable the electronic device to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
applying a set of common device-specific definitions for a user interface of a device;
using application-specific definitions to over-ride select common definitions, the application-specific definitions being applicable to one or more applications on the device; and
applying widget-type-specific definitions, each of the widget-type-specific definitions being applicable to one or more applications corresponding to a widget type.

2. The method of claim 1, wherein the common definitions are retrieved from a memory portion shared by two or more applications of the device.

3. The method of claim 1, wherein applying the widget-type-specific definitions comprises:
creating one or more lists of definitions for each of one or more widget classes; and
associating an application of the device with one or more of the lists of definitions based on one or more widget classes of the application.

4. The method of claim 1, wherein the set of common device-specific definitions and the application-specific definitions includes cascade style sheets.

5. The method of claim 4, wherein the cascade style sheets form layer stacks for one or more concerns associated with the user interface of the device.

6. The method of claim 1, wherein the device is a mobile device.

7. An apparatus, comprising:
at least one processor; and
at least one memory including computer program code, the at least one memory and the computer program code configured to, with the at least one processor, cause the apparatus to perform at least the following:
apply a set of common device-specific definitions for a user interface of a device;
use application-specific definitions to over-ride select common definitions, the application-specific definitions being applicable to one or more applications on the device; and
apply widget-type-specific definitions, each of the widget-type-specific definitions being applicable to one or more applications corresponding to a widget type.

8. The apparatus of claim 7, wherein the common definitions are retrieved from a memory portion shared by two or more applications of the device.

9. The apparatus of claim 7, wherein applying the widget-type-specific definitions comprises:
creating one or more lists of definitions for each of one or more widget classes; and
associating an application of the device with one or more of the lists of definitions based on one or more widget classes of the application.

10. The apparatus of claim 7, wherein the set of common device-specific definitions and the application-specific definitions includes cascade style sheets.

11. The apparatus of claim 10, wherein the cascade style sheets form layer stacks for one or more concerns associated with the user interface of the device.

12. The apparatus of claim 7, wherein the device is a mobile device.

13. A computer-readable memory including computer executable instructions, said computer executable instructions, when executed by a processor, cause an apparatus to perform the following:
apply a set of common device-specific definitions for a user interface of a device;
use application-specific definitions to over-ride select common definitions, the application-specific definitions being applicable to one or more applications on the device; and
apply widget-type-specific definitions, each of the widget-type-specific definitions being applicable to one or more applications corresponding to a widget type.

14. The computer-readable memory of claim 13, wherein the common definitions are retrieved from a memory portion shared by two or more applications of the device.

15. The computer-readable memory of claim 13, wherein applying the widget-type-specific definitions comprises:
creating one or more lists of definitions for each of one or more widget classes; and
associating an application of the device with one or more of the lists of definitions based on one or more widget classes of the application.

16. The computer-readable memory of claim 13, wherein the set of common device-specific definitions and the application-specific definitions includes cascade style sheets.

17. The computer-readable memory of claim 16, wherein the cascade style sheets form layer stacks for one or more concerns associated with the user interface of the device.

18. The computer-readable memory of claim 13, wherein the device is a mobile device.
